(19) United States
(12) Patent Application Publication
(10) Pub. No.: US 2013/0001140 A1
(43) Pub. Date: Jan. 3, 2013

(54) DEVICE AND METHOD FOR PROCESSING SMALL, LIGHTWEIGHT OBJECTS

(75) Inventor: Peter Kok, Apeldoorn (NL)

(73) Assignee: IMIX VISION SUPPORT SYSTEMS B.V., Apeldoorn (NL)

(21) Appl. No.: 13/634,922

(22) PCT Filed: Mar. 15, 2011
(86) PCT No.: PCT/NL2011/050178

§ 371 Date: Sep. 14, 2012

(30) Foreign Application Priority Data
Mar. 16, 2010 (NL) 2004408

(51) Int. Cl. B07C 5/36

(52) U.S. Cl. 209/552

(57) ABSTRACT

A device (1) for processing a batch of small light weight objects includes a tray filling section (3) configured for scattering small light weight objects on the top surface of a tray, an inspection section (5) configured for determining for each pocket of the array of pockets a quality measure associated with the object in the pocket, a selective removal section (4) configured for selectively removing objects from the array of pockets in dependence of the quality measure for each pocket and, a control unit (11) configured for controlling the tray filling section, the inspection section and the selective removal section. The device further includes a transportation unit (7) configured for repeatedly vice versa and linearly moving the tray from a first position (8) to a second position (9) along the tray filling section, inspection section and selective removal section.

### TECHNICAL FIELD OF THE INVENTION

The invention relates to a device for processing small, lightweight objects defined by the preamble of claim 1, more particular to a seed processing device. The scope of application is for analysing, grading and sorting batches of small, lightweight objects.

### BACKGROUND OF THE INVENTION

A sorting device for sorting small, lightweight object, especially seeds is commercially available on the market and known as iXeed. The seed sorting device is configured to inspect each individual seed from a batch of seed and to remove seed with characteristics below required characteristics. In this way, the quality of a batch of seed is improved, which increases the value of the batch of seed.

The sorting device comprises an endless chain provide with trays along the whole length of the end less chain. Each tray comprises an array of pockets in its top surface. A pocket has a size and depth such that one piece of seed fits in the pocket and will normally stay in the pocket when the tray is moved back and forth in horizontal direction. Furthermore, a pocket has an oval or elliptic shape such that after the pockets are filled with seed, the seed in the pockets have substantially the same orientation. For objects having a substantially round shape, the pockets may have a round shape. The tray further comprises air channels from the underside of the tray to a pocket. When air is blown in the air channel from the underside, seed that is in a pocket will be blown out of the pocket.

In the known sorting device, the trays are coupled to the endless chain and go around with a constant speed and passes each round subsequently a tray filling part, a seed surplus removing part, a visual inspection part, a selective seed removal part and a remaining seed removal part. In the tray filling part, a flow of seed is falling on each tray. In the seed surplus removing part, a tray is moved in a direction perpendicular to the direction of the endless chain. In this way, the seeds are moved in the pockets and a surplus of seed is shifted to the edges of the tray to fall off from the tray. After the seed surplus removing part only seed is in the pockets and no seed is present on the top surface of the tray between the pockets. Then the tray with seed in the pockets passes the visual inspection part. In this part by means of an image sensor one or more images are taken from the upper side. The images are analyses to determine for each pocket the characteristics of the seed in said pocket. Characteristics of a seed that could be used be: surface, length, width, symmetry, colour, dent, deformations, twists, mechanical damage, colour distribution, more than one seed in pocket, etc. The characteristics are used to determine for each individual seed a quality measure. This quality measure is used to determine whether a seed in a pocket has the minimal desired quality. If a seed in a particular pockets has at least the minimal desired quality, in the selective seed removal part, the seed is blown out of the pocket by means of a nozzle into the space above the tray. A puff of air from the nozzle is blown in the direction of the opening of a channel in the underside of a tray resulting in an air flow through the channel to the pocket. A seed in a pocket is above the opening of the channel. The puff resulting in the air flow causes the seed to move into the air above the tray. A first suction unit above the tray sucks away the seed blown out of the pocket and collects the seed with the desired quality in a container. Finally, the seeds not having the minimal desired quality which are still on the tray are removed from the tray and collected in another container. Then the empty tray is transported to the tray filling part again to start a subsequent sorting cycle.

### SUMMARY OF THE INVENTION

The object of the invention is to provide an improved device for processing small lightweight objects, which can be used for sorting, grading, analysing and counting a batch of small light weight objects.

According to the invention, this object is achieved by device having the features of claim 1. Advantageous embodiments and further ways of carrying out the invention may be attained by the measure mentioned in the dependent claims.

According to the invention, is characterized in that, the device comprises transportation unit configured for repeatedly vice versa and linearly moving the tray from a first position to a second position, wherein the tray enters the tray filling section, inspection section and selective removal section when moved from the first position to the second position. These features enable one to obtain a very compact device compared to the known device, a device which can quickly be converted for sorting different type of objects and types of the mentioned operations. Another advantage is that the device comprises less parts which can be polluted with said object and consequently is faster cleaned when converting the device to perform another operation.

In an embodiment of the invention, the transportation unit comprises a linear actuator to move the tray repeatedly between the first position and the second position. These features enable the device to have only one actuator to generate all movements necessary to move the tray and to process the objects.

In an embodiment of the invention, at the first position the tray is in the tray filling section, at the second position the tray is in the inspection section and the selective removal section is located between the first and second position. It has been found that these features provide very small sizes of device.

In an embodiment of the invention, the device comprises a control unit configured to control the tray filling section to scatter a predetermined period of time or predetermined amount of small light weight objects on the top surface of the tray.

In an embodiment of the invention, the control unit is configured to alternately move the tray over a predetermined distance between the first and second position, wherein the movement in the direction of the first position differs from the movement in the direction of the second position. This movement along the path of the tray has been made possible by using a linear actuator.

In an embodiment of the invention, the device comprises a collecting unit positioned below the tray filling section, inspection section and selective removal section, wherein the collection unit forms a tapering bin which tapers from its topside to its underside and configured to collect the small light weight object that fall down along the tray or from the tray when handling the tray. Due to the limited area in which the objects are transported during processing, only one collection hopper is sufficient to collect object falling of or along the tray. In an advantageous embodiment, the collection unit is pyramid or cone shaped. The hopper may be divided in several compartments.

In an embodiment of the invention, tray filling unit comprises a storage for storing the small lightweight objects before they are scattered, wherein the air channel coupled to the underside of the collection unit configured to move the small lightweight objects falling in the collection unit to the storage. These features enable to device to sort all objects in one run.

In an embodiment of the invention, the selective removal section comprises a blow unit and a suction duct and the device is configured to divide the objects on a tray in at least two groups of objects with different classification. In a further embodiment, the tray at least two times passes said blow unit and suction duct to remove said at least two groups of objects. By having the linear vice versa linear movement of the tray, it is possible to have the sorting function with only one pair of blow unit and suction duct.

It is a further aspect of the invention to provide an improved method of sorting, grading and/or analyzing batches, counting of small light weight objects, in particular seed, which requires less space, is more efficient. The method comprises supplying a batch of small lightweight objects to an arrangement comprising all technical features of a device according to the invention, to obtain one or more batches of small lightweight objects with at least one determined characteristic. For counting, one or more batches could be obtained with determined count of objects for each batch. For analysing, grading, one or more batches could be obtained with determined characteristic, such a distribution of size or quality measure. For sorting, two or more batches are obtained, each batch comprising objects complying with a predetermined characteristics

It will be clear that the various aspects mentioned in this patent application may be combined and may each be considered separately for a divisional patent application. Other features and advantages of the invention will become apparent from the following detailed description, taken in conjunction with the accompanying drawing which illustrate, by way of example, various features of preferred embodiments of the invention.

### BRIEF DESCRIPTION OF THE FIGURES

These and other aspects, properties and advantages of the invention will be explained hereinafter based on the following description with reference to the drawings, wherein like reference numerals denote like or comparable parts, and in which:

FIG. 1 illustrates an embodiment of the device according to the invention; and

FIG. 2 shows a perspective view of another embodiment of the invention.

### DESCRIPTION OF EMBODIMENTS

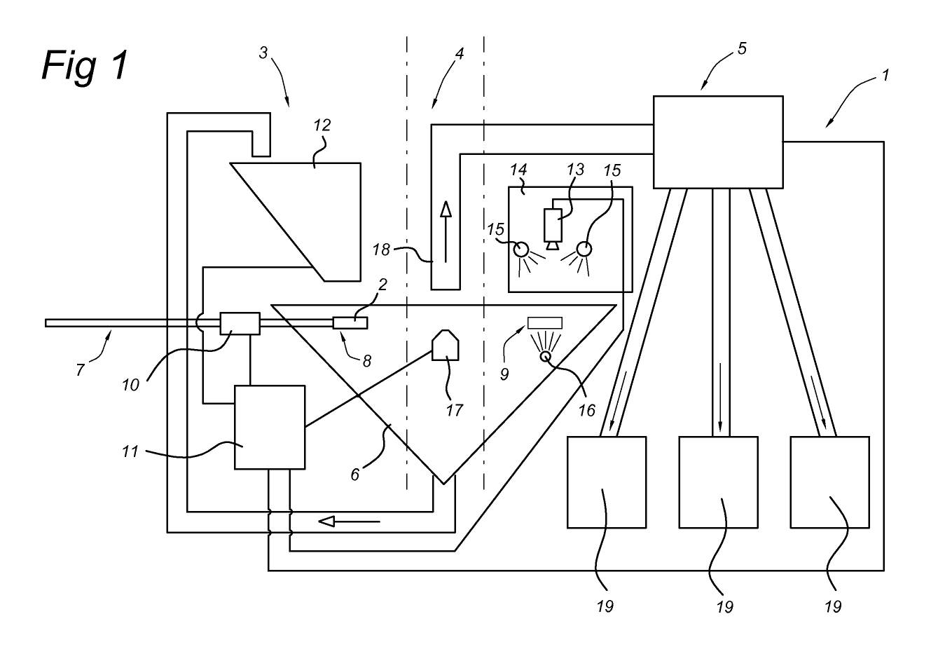

FIG. 1 illustrates an exemplar embodiment of a device for processing a batch of small light weight object according to the invention. In the context of the present invention, small light weight objects are objects which can easily be moved in an air stream through a duct. Examples of small light weight object are seeds, pills or any other object in the form of a pill. The objects are preferably objects of a batch which comprises object of different quality, which value can be increased by dividing the batch in smaller batches of objects with a more constant quality. In the context of the present invention, processing means at least one of the following processes: counting, analyzing, grading and sorting. Counting is counting the number of objects in the batch. Analyzing is determining at least one characteristic of the batch of objects. Some characteristics of a batch of seed are: the distribution of size, distribution of surface colour, distribution of length/width of seed, distribution of estimated weight of objects. Grading is determining a quality value for each object and subsequently determining the distribution of amount of objects having predefined quality values. Sorting is dividing the batch in to portions based on at least one characteristic.

The device 1 comprises a tray filling section 3 configured for scattering small light weight objects on the top surface of a tray 2, an inspection section 5 configured for determining for each pocket of the array of pockets a quality measure associated with the object in said pocket, and a selective removal section 4 configured for selectively removing objects from said array of pockets in dependence of the quality measure for each pocket, and a control unit 11 configured for controlling the tray filling section, the inspection section and the selective removal section.

The device further comprises transportation unit 7 configured for repeatedly vice versa and linearly moving a tray from a first position 8 to a second position 9. In the first position 8, the tray is positioned in the tray filling section 3. In the second position 9, the tray is in the inspection section. When moving from the first position 8 to the second position 9, the tray passes the selective removal section 4. In should be noted that the position of tray filling section 3, selective removal section 4 and inspection unit 5 could be changed without departing from the scope of the present invention.

The transportation unit 7 comprises a linear actuator 10 provided with a elongated body, for example a bar. The linear actuator 10 is configured to move the elongated body along its longitudinal axis. A tray 2 is attached to an end of the elongated body.

In use, the device 1 repeatedly performs the following operations. In the tray filling section 3 the tray is in the first position. A storage 12 above the tray is filled with a batch of seed to be sorted. From an outlet of the storage 12 the seeds are scattered above the tray 2. The scattering from the storage could be continuously even if no tray is below the outlet. Preferably, the control unit 11 is configured to control the tray filling section to scatter a predetermined period of time or predetermined amount of small light weight objects on the top surface of the tray when the tray is below the opening of the storage 12. Then the linear actuator 10 moves the tray 2 alternately over a short distance along the longitudinal axis of the elongated body. The movement, i.e. acceleration, in the direction of the first position differs from the movement in the direction of the second position. By having such an asymmetric movement, the seed on the top surface of the tray and not secured in a pocket will be moved in one direction till they fall down along the border of the tray. Now only objects are present in the pockets. Subsequently, the tray is transported by the transportation unit 7 to the inspection section 5. The inspection section includes one or more imaging devices 13 arranged for capturing images of the tray and the seed in the pockets. The imaging device 13 could be a camera, a line scanner, a laser scanner, X-ray detector or any combination thereof. In case of a camera to provide optimal image capturing conditions the camera is positioned in a housing to shield ambient light. Furthermore, light source 15 are positioned in the housing, to provide a homogenous exposure of light on the tray. With a laser scanner, a contour image is made from which the structure or shape of the shape can be determined. In case the imaging device 13 is an X-ray detector, an X-ray source 16 is positioned such that the tray can be positioned in the beam of X-rays and the detector can detect the intensity of the X-rays passing through the seed. In this way, the internal structure of the seed can be determined from the image, which provided further information about the quality of the seed. Furthermore, the outline of the seed can be derived from the X-ray image. The images captured by the imaging device 13 are analysed and each seed in a pocket will obtain a qualification value indicating the quality of the seed in the pocket.

After calculation of a qualification value for each of pockets, the tray is moved to the selective removal section 4. The selective removal section comprise a blow head configured for selectively blowing seed out of a pockets when a pocket having a particular qualification value passes an outlet of the blow head 17. A suction unit 18 having a duct with an open end above the tray will suck the seed blown out of the pockets and transport the seed in an air flow to a container 19 assigned to receive the objects with said particular qualification. By moving the tray one time between the blow head and the inlet of the suction unit, all objects with a first qualification value are removed from the tray and collected in an assigned first container. By moving the tray a second, third, etc time between the blow head and inlet of the suction unit 18, all object with a second, third, etc, qualification value are removed from the tray and collected in a container associated with said second, third, etc qualification value. For example, the first time the tray passes along the blow head, the seed with the lowest quality are removed. The second time seed with a better quality are removed from the tray, and finally all remaining objects having the best quality are removed from the tray. It might be clear that the skilled person can choose any other order for selectively removing the objects from the tray. The control unit 11 is configured to control each of the outlets of the blow unit independently in dependence of the qualification values. It should be noted that for the last movement of the tray between the blow head and suction unit 18, all outlets may continuously blow into all pockets of the tray, as at said move all object have to be removed from the tray. After all object have been removed from the tray, the transportation unit 7 will transport the tray to the begin position of the processing cycle described above, i.e. the position in the filling section 3 to scatter for a next cycle object on the tray.

The device 1 further comprises a collection unit 6 configured to collect all objects falling down from the tray or along the tray when handling the tray as described above. The collection unit 6 forms a tapering bin which tapers from its topside to its underside. All objects falling along the tray will be collected at the bottom of the collection unit 6. An airflow will transport the object collected at the bottom of the collection unit 6 to the storage 12 of the tray filling section. In this way, the objects not handled correctly such that they will arrive in one of the containers, will be scattered again and again above the tray in the filling section and further processed until they will arrive in one of the containers 19.

The quality of seed in one of the containers can be improved, i.e. made more homogenous, be supplying the content of one of the container with a particular quality value to the storage 12. If the qualification was correctly performed, all object will obtain again the same qualification value and will be collected in the container associated with said particular quality value. However, due to the orientation of the object in a pocket, different qualification values can be obtained for the same object. Thus when a batch of seed with a predetermined quality value is supplied a second time to the device, a percentage of the object will not obtain again the same quality value. This repeated handling of a batch of objects will improve the quality of the batch.

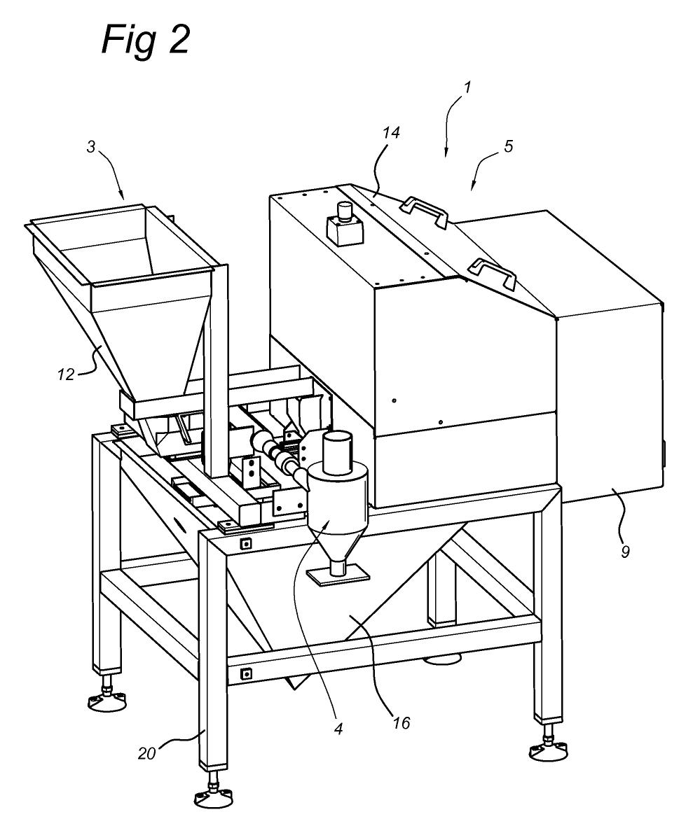

FIG. 2 shows a perspective view of another embodiment of the device according to the invention. The device 1 comprises a frame to which the collection unit 20, storage 12 of the filling section 3, the suction unit 4 and inspection unit 5 are attached. In this embodiment, the linear actuator is positioned at the side of the inspection unit 5. Furthermore, the control unit 9 is positioned in a housing attached to the inspection unit 5 comprising the imaging device and light sources.

In the exemplar embodiment given above the tray comprises pockets. If the device is used for counting seed in a batch, analyzing a batch of seed or grading a batch of seed, other types of a tray could be used. For performing these operations, a selective removal section can be replaced by a removing section which removes without selection all objects from a tray.

In an embodiment, a tray has a flat surface. By means of the filling section objects are scattered on the flat surface. By moving the tray repeatedly forward and backward, the objects will be distributed across the top surface and some will fall of the tray. Generally, after moving the tray forward and backward, only one layer of objects will be on the top surface of the tray. In the inspection section an image is captured from the tray with object. This image will be processed by commonly known image processing techniques. By means of image processing can be determined if all objects can be individual identified. Objects could not be individual identified if they touch each other or when they lay upon each other. If not all object can be individual identified, the tray is moved back to the tray filling section and again repeatedly moved forward and backward to reorder the objects. As soon as the objects are such that they can individually identified, the number of objects can be determined from the image or one or more characteristics can be determined for each of the objects. This enables the device to count the number of objects or the determine distributions for characteristics of a batch of objects.

When using a tray with a flat surface, the objects on the tray can be removed by moving the tray fast and to stop abruptly in a position. The objects in the tray will then slide over the top surface and drop down in to a hopper positioned below the tray. It is also possible to used the same motions for moving the objects into the pockets described above. In these cases, the inspection section and removal section can be combined into one section.

In another embodiments, the objects are removed by a blow unit or suction unit.

A linear actuator makes it possible to have large trays, i.e. a tray which dimension perpendicular to the direction of the linear actuator is too large to capture an image by the imaging device. In that case a second linear actuator could be used to move the tray in a direction perpendicular to the movement of the first linear actuator. In another embodiment, the imaging device is attached to the second linear actuator and moved in a direction perpendicular to the movement of the first linear actuator to enable the device to capture an image of the full area of the tray.

In an embodiment, the tray is configured to suck objects to the top surface of the tray. This embodiment is advantageous in case the objects do not have a similar profile. The objects stick to the surface by suction. In this embodiment, the top surface could be flat and comprises small openings coupled to a vacuum pump. In the filling section, objects are scattered on the tray and the tray is moved forth and backwards until all openings at the top surface are covered with an object and objects not covering an opening are removed from the top surface. Then the objects are further processed in the inspection section and/or removal section.

In an embodiment, the top surface of a tray is on a pivot. The slanted top surface could be advantageous when moving surplus objects from the tray in the filling section and removing all remaining objects from the tray after processing.

In an embodiment, the top surface of a tray is removable. The top surface in this embodiment comprises an array of pockets for receiving an object. This embodiment enables one to use the device for determining for each object one or more characteristics and to link the one or more characteristics to the corresponding pocket which comprises said object. In case the objects are seed, the linkage of the one or more characteristics to the seed in the pocket, the information could be used for improving the algorithms for sorting the seed. By knowing the seed characteristics of a particular seed, the growing performance of said seed to a plant could be measured to obtain growing characteristics indication the real performance of particular seed. Correlation between the seed characteristics measured with the device and the growing characteristics will provide information to improve the sorting of seed by means of the device. To ensure that after analysing the object by means of the device the objects are secured in the pockets, the device could comprise a sealing arrangement, for sealing the objects.

Instead of a removable top surface, the device could comprise an arrangement configured to adhere the objects on the top surface to a sticky layer after analysing the objects on the top surface. The sticky layer is then used as carrier for carrying the seed. The sticky layer could be in the form of an adhesive tape or plate provided with an adhesive layer.

It might be clear that if no suction unit is used, below the path of the tray the device comprises a collection unit with two compartments. A first compartment which is positioned in at least the filling section and a second compartment in at least the inspection section. In the first compartment objects are collected which are not counted or analysed and in the second compartment counted and/or analysed objects are collected.

The measures described hereinbefore for embodying the invention can obviously be carried out separately or in parallel or in a different combination or if appropriate be supplemented with further measures; it will in this case be desirable for the implementation to depend on the field of application of the device. The invention is not limited to the illustrated embodiments. Changes can be made without departing from the idea of the invention.

1. Device (1) for processing a batch of small light weight objects, the device comprising
a tray (2) comprising a top surface (2a) suitable for carrying small light weight objects;
a tray filling section (3) configured for scattering small light weight objects on the top surface of a tray;
an inspection section (5) configured for determining one or more characteristics of the objects on said tray;
a removal section (4) configured for removing objects from tray; and,
a control unit (11) configured for controlling the tray filling section, the inspection section and the selective removal section,
characterized in that,
the device comprises transportation unit (7) configured for repeatedly vice versa and linearly moving the tray from a first position (8) to a second position (9), wherein the tray enters the tray filling section, inspection section and selective removal section when moved from the first position to the second position.

2. Device according to claim 1, characterized in that, the transportation unit (7) comprises a linear actuator (10) to move the tray repeatedly between the first position (8) and the second position (9).

3. Device according to claim 1, characterized in that, at the first position the tray is in the tray filling section, at the second position the tray is in the inspection section and the selective removal section is located between the first and second position.

4. Device according to claim 1, characterized in that, the control unit (11) is configured to control the tray filling section to scatter a predetermined period of time or predetermined amount of small light weight objects on the top surface of the tray.

5. Device according to claim 1, wherein the control unit (11) is configured to alternately move the tray over a predetermined distance between the first and second position, wherein the movement in the direction of the first position differs from the movement in the direction of the second position.

6. Device according to claim 1, characterized in that, the device comprises a collecting unit positioned below the tray filling section, inspection section and removal section, wherein the collection unit forms a tapering bin which tapers from its topside to its underside and configured to collect the small light weight object that fall down along the tray or from the tray when handling the tray.

7. Device according to claim 6, wherein the collection unit is pyramid or cone shaped.

8. Device according to claim 6, wherein the tray filling unit comprises a storage for storing the small lightweight objects before they are scattered, wherein the air channel coupled to the underside of the collection unit configured to move the small lightweight objects falling in the collection unit to the storage.

9. Device according to claim 1, wherein the selective removal section comprises a blow unit and a suction duct and the device is configured to divide the objects on a tray in at least two groups of objects with different classification.

10. Device according to claim 9, wherein the tray at least two times passes said blow unit and suction duct to remove said at least two groups of objects.

11. Device according to claim 6, wherein the collection unit comprises a first compartment and a second compartment, the first compartment being positioned below the tray in at least the tray filling section and the second compartment being positioned below the tray in at least to inspection section.

12. Method of processing a batch of small, lightweight objects, the method comprising, supplying a batch of small lightweight objects to an arrangement comprising all technical features of a device according to claim 1, to obtain one or more batches of sorted small lightweight objects with at least one known characteristic.

13. Device according to claim 2, characterized in that, at the first position the tray is in the tray filling section, at the second position the tray is in the inspection section and the selective removal section is located between the first and second position.

14. Device according to claim 2, characterized in that, the control unit (11) is configured to control the tray filling section to scatter a predetermined period of time or predetermined amount of small light weight objects on the top surface of the tray.

15. Device according to claim 2, wherein the control unit (11) is configured to alternately move the tray over a predetermined distance between the first and second position, wherein the movement in the direction of the first position differs from the movement in the direction of the second position.

16. Device according to claim 2, characterized in that, the device comprises a collecting unit positioned below the tray filling section, inspection section and removal section, wherein the collection unit forms a tapering bin which tapers from its topside to its underside and configured to collect the small light weight object that fall down along the tray or from the tray when handling the tray.

17. Device according to claim 7, wherein the tray filling unit comprises a storage for storing the small lightweight objects before they are scattered, wherein the air channel coupled to the underside of the collection unit configured to move the small lightweight objects falling in the collection unit to the storage.
